(19) United States
(12) Patent Application Publication
(10) Pub. No.: US 2017/0289165 A1
(43) Pub. Date: Oct. 5, 2017

(54) Systems and methods for providing visualization of Geo location of pupil transportation buses

(71) Applicants: Hernan Asorey, San Francisco, CA (US); Sylvia Tschubarov, New York, NY (US)

(72) Inventors: Hernan Asorey, San Francisco, CA (US); Sylvia Tschubarov, New York, NY (US)

(21) Appl. No.: 15/091,479

(22) Filed: Apr. 5, 2016

(51) Int. Cl. H04L 29/06; G06F 17/30

(52) U.S. Cl. CPC H04L 63/101; G06F 17/30241; G06F 17/30867

(57) ABSTRACT

A computer-implemented system and method that includes receiving a request to know the Geo location of a pupil transportation vehicle (“Yellow School Bus”or “YB”) for a requested route (assigned specifically to one student) and displaying such request of the Geo location of the vehicle on a smartphone, tablet, laptop, or personal computer system. Such system and method will improve the retrieval of location of the YB by parents or caregivers, thus being able to better manage and plan their timing to reach the Yellow Bus stop. Such system and method will allow the users to generate alerts on demand. Such system will allow to provide key performance indicators for the office of student transportation of the city in which will be implemented.

### FIELD OF THE INVENTION

The invention relates to tracing a Yellow School Bus with a Geo location device, and displaying the Geo location of such bus on the screen of a smartphone, tablet or personal computer. The purpose of the invention is to grant access of this bus information to parents or caregivers of pupils so they can manage their schedules more efficiently, as they will know if the bus is on time or delayed.

### BACKGROUND OF THE INVENTION

As of today, the only way parents or caregivers have access to a YB location for a specific route assigned to their children is to call a phone number, the operator will ask the parent for a route and YB stop, communicate via radio with the driver assigned to such route and talk back to the parent/caregiver about how far from the YB stop the YB is. During inclement weather, whatever the delay for the YB, even if known by phone, happens at the YB stop.

The system will bring an improvement to the actual situation because it will display real-time Geo location of the YB visualized on a map, along with traffic information and will enable parents or caregivers to accordingly plan their way to the YB stop.

In today's digital environment, protecting user information and user resources from unauthorized access is increasingly important. Accordingly, different ways of verifying that a user “is who they say they are” have been developed. Such processes and techniques are typically referred to as user authentication. Authentication is utilized by this computer system to determine which type of user is connecting to the system: parent, school, police or other city respondents or city's pupil transportation users.

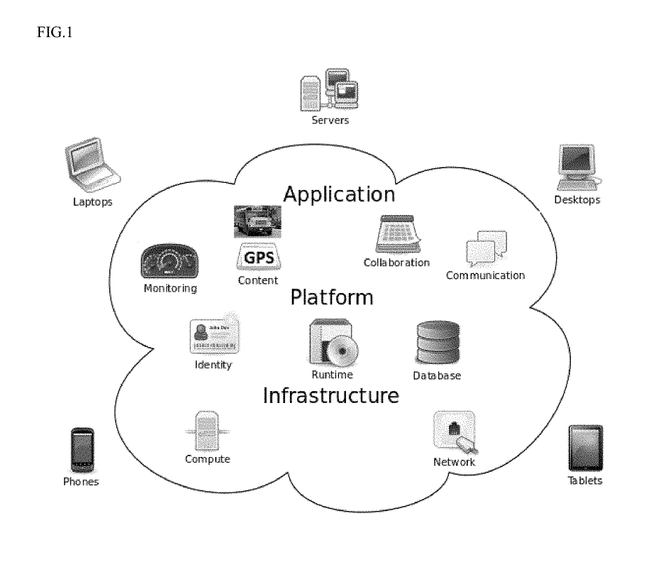

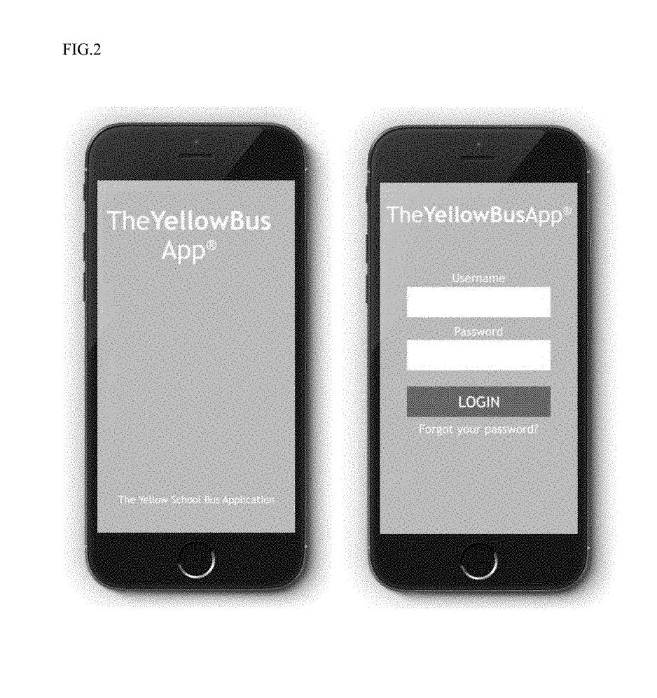

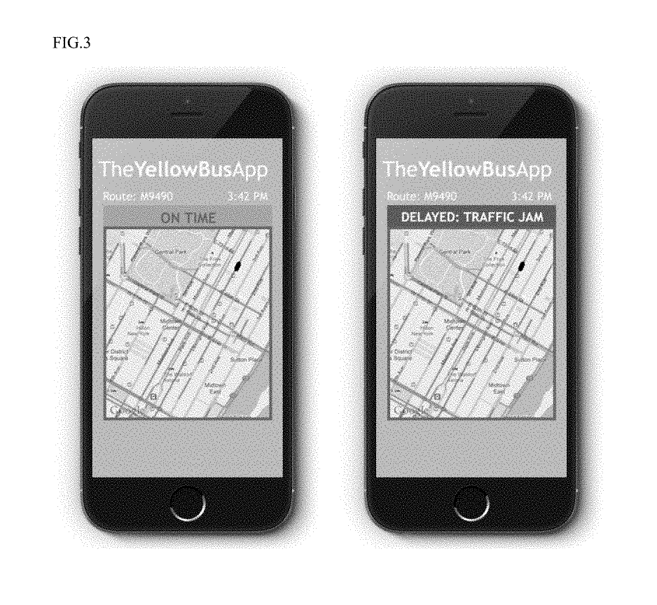

In addition to authentication for access to user resources, controlling permissions for access to different types and/or instances of user resources is important. For instance, consider that a user has an account with a social media platform. The user's account may be associated with a variety of different types of content, such as user profile information (e.g., name, gender, date of birth, and so on), a list of the user's social media connections (e.g., friends), instances of content posted by the user (e.g., photos, videos, and so forth), contact information for the user, and so on. The user may wish to limit the type of content that may be accessed by various entities and/or individuals. For instance, a user may allow an application or other service to access the user's profile information, but may want to prevent the application from accessing other types of the user's content, such as photos. Systems and methods for providing visualization of Geo location of pupil transportation buses BRIEF DESCRIPTION OF THE DRAWINGS FIG. 1 is a diagram that illustrates an exemplary YB location system in accordance with one or more embodiments of the present technique. FIG. 2 is a diagram that shows the User Interface for the application (on a phone or tablet) user authentication. FIG. 3 is a diagram that illustrates how the system will show (User Interface/User Experience) the YB Geo location on a map displayed on a multiplatform device way. The oblong dot on the map is the representation of the YB.

1. A system comprising: a fleet of YB traceable by a Geo location system, such data of the YB tracking will be stored in a database; an application enabling one type of users (parents of children assigned to YB) to access real-time and only for that moment, Geo location of the YB route that is carrying their children; same application enabling a second type of users (schools, police, city responders or other city offices) to locate and trace one or more YB; an application to analyze data from such database to produce key performance indicators for the YB pupil transportation system.

2. A system as described in claim 1, wherein the real-time YB for a specific route location is displayed on a map on an array of multiplatform devices such as tablets, smartphones, PC systems and laptops.

3. A system as described in claim 1, wherein the type of access includes one of read-only access or push alerts from the subset of the user content.

4. A system as described in claim 1, wherein said generating comprises including, in the access for a username/password, at least one of an expiration time or an expiration date for the username/password access.

5. A system as described in claim 1, wherein the operations further comprise utilizing the access of username/password as a temporary identifier for the network/system resource.

6. A computer-implemented method, comprising: ascertaining a scope of access to user content of a resource user to which a network resource is permitted (YB location), the user content being arranged in a content hierarchy and the scope including a reference to a level of the hierarchy that corresponds to a subset of the user content; generating an access token by: generating a uniform resource identifier (URI) that includes an identifier for the network resource, an identifier for the resource user, an indication of the scope, and a type of access permitted to the network resource, the URI being directly abled to be mapped to the subset of the user content; encoding the URI to generate the access token; and providing the access token to the network resource to enable the network resource to request access to the subset of the user content.

7. A computer-implemented method as recited in claim 6, wherein said ascertaining comprises: querying the resource user for the scope of access; and receiving, in response to the query, input from the resource user specifying the scope of access.

8. A computer-implemented method as recited in claim 6, wherein said generating further includes generating the token to include at least one of an expiration time or an expiration date for the access of the username/password.

9. A computer-implemented method as recited in claim 6, wherein said generating further comprises generating the URI to include a type of access permitted for the resource user to the subset of the user content, the type including one of read-only access or read and write access.

10. A system as described in claim 1, wherein said ascertaining comprises:
querying the resource user for the scope of access; and receiving, in response to the query, input from the resource user specifying the scope of access.

11. A system as described in claim 1, wherein the operations further include creating an access control entry for the user content which includes the indication of the scope and the type of access permitted to the network resource.

12. A computer-implemented method as recited in claim 6, further comprising creating an access control entry for the user content which includes the indication of the scope and the type of access permitted to the network resource.

13. A computer-implemented method as recited in claim 6, further comprising utilizing the access token as a temporary identifier for the network resource.

14. A computer-implemented method as recited in claim 6, further comprising ascertaining that the access token is at least one of expired or revoked; and in response to said ascertaining, preventing further access the subset of user content via the access token.

15. One or more computer-readable storage media having instructions stored thereon that, responsive to execution by one or more processors, cause the one or more processors to perform operations comprising analytics of stored YB Geo location and data to obtain key performance indicators.

16. A system as described in claim 1, further enhanced with traffic information and on-demand user alerts to indicate distance from home of the user for better decision making for parents and caregivers.
